(19) United States
(12) Patent Application Publication
(10) Pub. No.: US 2012/0299372 A1
(43) Pub. Date: Nov. 29, 2012

(54) DETACHABLE GROUSER SPIKES FOR ENHANCES TRACTION OF CONTINUOUS TRACK VEHICLES

(76) Inventor: Guy Kruger, Brigham City, UT (US)

(21) Appl. No.: 13/007,624

(22) Filed: Jan. 15, 2011

(51) Int. Cl. B62D 55/28

(52) U.S. Cl. 305/192; 305/191

(57) ABSTRACT

Traction enhancing detachable spikes are disposed on, and between, the grousers and the shoes of continuous tracks of motorized vehicles such as bull dozers, excavators, tanks, skid steers and the like. Spike receptacles are permanently affixed to the track of continuous track construction machinery, which spike receptacles house outwardly protruding spikes. The spikes are easily detachable and removable from the spike receptacle to facilitate use of the subject motorized vehicles on flat and graded surfaces, such as pavement.

### BACKGROUND OF THE INVENTION

1. Field of the Invention

This invention relates to continuous tracks, and more particularly relates to an apparatus and structure for improving the traction of continuous track mechanized vehicles.

2. Description of the Related Art

Continuous tracks are used to propel heavy mechanized vehicles such as bull dozers, skid steers, cranes, excavators, and tanks across uneven and ungraded surfaces. Continuous tracks often comprise modular metal plates, or shoes, linked into a continuous band and driven by a plurality of wheels. The great surface area of the tracks relative to tires and other propulsions systems distributes weight better than steel or rubber tires on an equivalent vehicle, enabling a continuous tracked vehicle to traverse soft ground with less likelihood of becoming stuck due to sinking. The prominent treads of the metal plates are both hard-wearing and damage resistant, especially in comparison to rubber tires. The aggressive treads of the tracks provide good traction in soft surfaces but can damage paved surfaces. Special tracks that incorporate rubber pads can be installed for use on paved surfaces to prevent the damage that can be caused by all metal tracks.

Many forms of continuous track comprise grousers, or cleats, which are protrusions on the surface of a wheel, shoe or continuous track segment, intended to increase traction in soil, snow, or other loose material. Track segments which incorporate grouser bars are known as grouser shoes, and typically include one to three grousers. Grousers are commonly used on construction vehicles such as bulldozers, loaders, and excavators, as well as tanks, agricultural vehicles, and snowmobiles.

Traditional grousers provide traction only along a single axis running generally parallel to the subject vehicles direction of travel. Traditional grousers do not provide traction for a subject vehicle along a laterally running axis, or an axis running perpendicular to the subject vehicles direction of travel. In fact, because grousers tend to suspend the continuous track above the ground on the grousers themselves, the grousers can act as skis, allowing a subject vehicle to slip sideways, sometimes great distances. There are numerous reported cases of bull dozers sliding laterally hundreds of feet, rolling, collided with expensive equipment and/or crushing other human beings.

Current continuous tracks and grousers provide no means of stabilizing, or enhancing, the lateral traction of a subject vehicle, which does not damage paved and graded surfaces. It is therefore desirable that a structure, or assembly, of continuous track be provided with enhances lateral traction and which does not cause a subject vehicle to damage graded surfaces.

### SUMMARY OF THE INVENTION

From the foregoing discussion, it should be apparent that a need exists for detachable grouser spikes for enhancing the traction of continuous track vehicles. Beneficially, such a drying apparatus would overcome many of the difficulties with prior art by providing a means for improving lateral traction with making use of components that will damages pavement and other graded surfaces.

The present invention has been developed in response to the present state of the art, and in particular, in response to the problems and needs in the art that have not yet been fully solved by currently available methods and apparatii. Accordingly, the present invention has been developed to provide a traction enhanced continuous track structure comprising: a plurality of sprockets disposed on a mechanized vehicle; a continuous track disposed around the sprockets comprising a plurality of ground engaging shoes; a plurality of spike receptacles affixed to one or more of the shoes, the spike receptacles defining one or more annularities for receiving detachable spikes; and a plurality of spikes detachably inserted into the spike receptacles, where in the spikes protrude outwardly away from the continuous track.

In some embodiments, the spike receptacles are welded to the outside surface of a shoe. In other embodiments, the spike receptacles are welded to one or more grousers on the continuous track. In still further embodiments, the spike receptacles are bolted to one or more grousers on the continuous track.

In some embodiments of the present invention, the spikes comprise drill bit tips, while in other embodiments, the spikes are detachable upon being rotated one of clockwise and counterclockwise.

The spikes may comprise one or more of tungsten carbide, polycrystalline diamond, cobalt steel, stainless steel, and iron. The spikes may be conical in shape.

In some embodiments, the spike receptacles are bored in a direction orthogonal to the direction of protrusion of the spikes such the housing may be bolted to a grouser on a continuous track.

The present invention also provides a spike receptacle for enhancing traction of continuous track on a mechanized vehicle, the spike receptacle comprising: a housing defining one or more annularities for receiving detachable spikes; and one or more spikes, each spike detachably inserted into single annularity, wherein the spikes protrude outwardly from the housing such that the spikes are parallel in orientation.

In some embodiments, the spikes comprise drill bit tips, while in other embodiments, the housing comprises a metal alloy. The housing may be bored in a direction orthogonal to the direction of protrusion of the spikes such the housing may be bolted to a grouser on a continuous track using the bore.

A second traction enhanced continuous track structure is disclosed comprising: a plurality of sprockets disposed on a mechanized vehicle for constructing buildings; a continuous track disposed around the sprockets comprising a plurality of ground engaging shoes; a plurality of grousers affixed to the shoes, each of the grousers defining spike receptacles on an outward edge of each grousers, the spike receptacles defining one or more annularities for receiving detachable spikes between 1 millimeter and 20 centimeters in diameter; and a plurality of spikes detachably inserted into the spike receptacles, wherein the spikes protrude outwardly away from the shoes.

In some embodiments of the traction enhanced continuous track structure, the spikes are each machined to define a recess circumventing each respective spike, the recess for receiving a tool for extracting spikes from the grouser.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side elevational perspective environmental view of a continuous track structure in accordance with the present invention;

FIG. 2 is a side elevational perspective environmental view of another embodiment of a continuous track structure in accordance with the present invention;

FIG. 3A is a side elevational perspective view of a spike receptacle in accordance with the present invention;

FIG. 3B is a side elevational perspective view of a spike receptacle in accordance with the present invention;

FIG. 3C is a top planar view of a spike for enhancing the traction of continuous track in accordance with the present invention;

FIG. 4A is a rear elevational perspective view of a spike receptacle in accordance with the present invention;

FIG. 4B is a forward elevational perspective view of a spike receptacle in accordance with the present invention;

FIG. 4C is a top planar view of a spike for enhancing the traction of continuous track in accordance with the present invention; and

FIG. 5 is a top planar view of a spike receptacle in accordance with the present invention;

FIG. 6A is a side elevational perspective view of a spike receptacle in accordance with the present invention; and

FIG. 6B is a top plan view of a spike receptacle in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

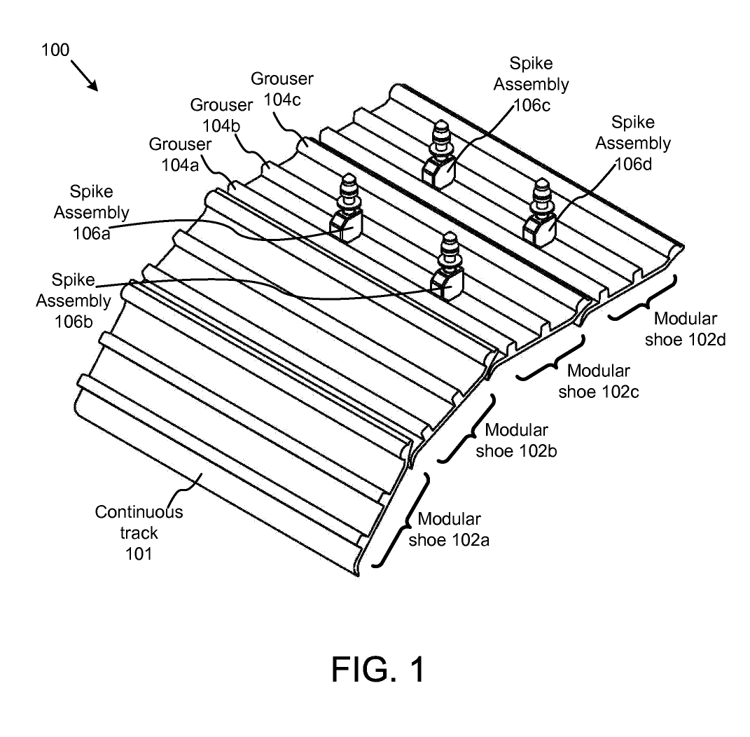

FIG. 1 is a side elevational perspective environmental view of a continuous track structure in accordance with the present invention. The continuous track structure 100 comprises a continuous track 101 comprising a modular shoe 102a, a modular shoe 102b, a modular shoe 102c, a modular shoe 103; a grouser 104a, a grouser 104b, a grouser 104c, a spike assembly 104a, a spike assembly 104b, a spike assembly 104c, and a spike assembly 104d.

The continuous track 101 is well-known to those of skill in the art. The continuous track 101 is used to propel heavy mechanized vehicles such as bulldozers, skid steers, cranes, excavators, tanks, and even snowmobiles across uneven and ungraded surfaces earthen or snow-covered surfaces.

The continuous track 101 comprises modular metal plates 102a-d, or modular shoes 102a-d, linked into a continuous band and driven by a plurality of wheels on the subject mechanized vehicle (not shown). The modular shoes 102a-d are damage resistant, and provide traction in soft surfaces.

In the shown embodiment, each of the modular shoes 102 comprise three grousers 104a-c. Grousers are well-known to those of skill in the art. In the shown embodiment, the grousers 104a-c form part of the modular shoes 102a-d. In other embodiments, the grousers 104a-c are bolted or welded to the shoes 102a-d, or otherwise permanently affixed thereto.

The grousers 104a-c substantially comprise cleats which protrude from the surface of a the shoes 102a-d, wheel, link, or continuous track segment, intended to increase traction in soil, snow, frozen grounds, loose aggregate, or other terrain. Track segments which incorporate grousers, or grouser bars, are known as grouser shoes, and typically include one to three grousers as shown in FIG. 1. Grousers are commonly used on construction vehicles such as bulldozers, loaders, cranes, and excavators, as well as tanks, and agricultural vehicles.

The continuous track 101 comprises, in the shown embodiment, four spike assemblies 104a-d (i.e. spike receptacle 104a-d). The spike receptacles 104a-d, in the shown embodiment, comprise a cubic, spherical, conical, hemispherical or cylindrical housings with a number of holes, bores, apertures, or annularities bored or drilled partially through one facet, surface, or side of the housing. These bores are for receiving a spike, which protrudes from the shoes 102a-d, engage the ground when the subject mechanized vehicle rolls across a graded or ungraded surface. The spikes prevent the subject vehicle from slipping laterally (e.g. slipping sideway), when the subject vehicle traverses a non-level surface.

In some embodiments of the present invention, the grousers 104a-c themselves comprise the spike assemblies 106a-d. The spike assemblies 106a-d may be accessible via the outside edge of the grousers 104a-c. In short, the grousers 104a-c may be manufactured to comprise the spike assemblies 106a-d.

In some embodiments of the present invention, the grousers 104a-c are forged, machined, or manufactured to serve as the spike assemblies 106a-d. In these embodiments, the outside edge of the grouser 104a-d comprises the bore, aperture or annularity into which the spikes are detachably inserted.

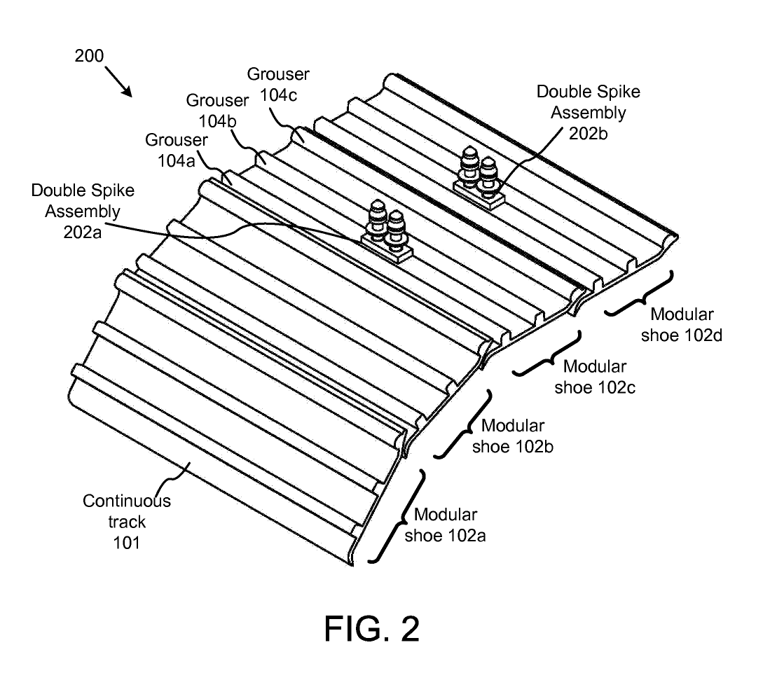

FIG. 2 is a side elevational perspective environmental view of another embodiment of a continuous track structure in accordance with the present invention. The continuous track structure 200 comprises a continuous track 101 comprising a modular shoe 102a, a modular shoe 102b, a modular shoe 102c, a modular shoe 102d; a grouser 104a, a grouser 104b, a grouser 104c, a double spike assembly 202a, and a double spike assembly 202b.

The continuous track 101, modular shoes 102a-d, and grousers 104a-c are all substantially described above in relation to FIG. 1.

In the shown embodiments, the double spike assemblies 202a-b are similar to the spike assemblies 106a-d in that both comprises housing which receive detachable, insertable spikes, however the double spike assemblies 202a-b receive a plurality of spikes. In the shown embodiment, the spikes all protrude in the same parallel direction from the housing.

In the sown embodiment, the double spike assemblies 202a-b are affixed between the grousers 104a-c to the shoes 102a-c. Alternatively, the double spike assemblies 202a-b may be welded to one or more of the sides of the grousers 104a-c.

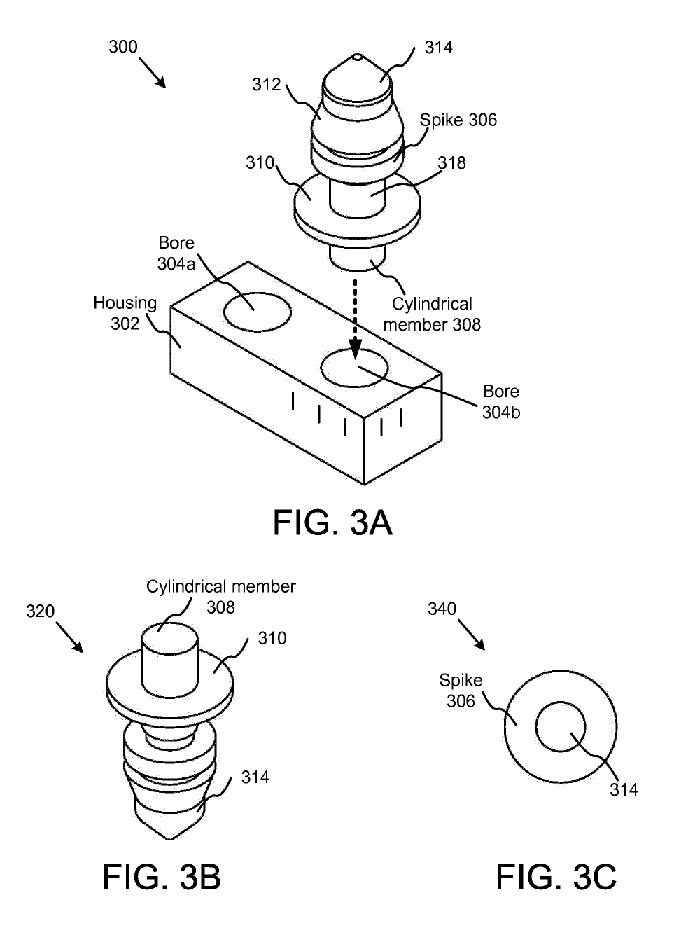

FIG. 3A is a side elevational perspective view of a spike receptacle 300 in accordance with the present invention. The spike receptacle comprises a housing 302, a bore 304a, a bore 304b, and a spike 306 comprising a cylindrical component 308, a ring component 310, a conical point 314, a flared component 312, and an axial recess 318.

The housing 302 defines two bores, holes, annularities or apertures for receiving a spike 306. The housing may be cubic in shape, spherical, hemispherical, polygonal, conical, and the like.

The spike 306 in the shown embodiment comprises an auger bit tip. The spike 306 may comprise a drill bit tip, a shank, a shaft, a spike, a bar, a spire, a cleat, and the like.

The spike 306 comprises a conically-shaped point 314, or tip, for engaging the ground over which the subject vehicle is rolling on the continuous track 101.

The spike 306 also comprises a ring component 310. The ring component 310 sits flush against the housing 302, a double spike assembly 202, or a spike assembly 106 when the spike 306 is inserted into any of the same.

The spike 306 also comprises a flared component 312, which comprises a portion of the spike 306 which is larger in diameter at its base than it is at its top. The flared component 312 sits beneath the point 314 and flush against it.

The spike 306 also comprises an axial recess 318, which is a recess circumventing the spike 306 machined into the spike 306 for receiving a tool for prying, or extracting, the spike 306 from the housing 302.

The spike 306, in some embodiments, freely rotates around their longitudinal (i.e. lengthwise) axis of the spike 306 within the double spike assembly 202 to reduce sheering of the spike 306. Alternatively, the spikes 306 may be welded, secured, or affixed to the double spike assembly, or receptacle, to prevent free rotation of the spikes 306 and to prevent the spikes 306 from being naturally extracted by the terrain over which the subject vehicle is moving.

The cylindrical member 308 of the spike 306 is detachably insertable into the housing 302.

FIG. 3B is a side elevational perspective view of a spike receptacle 320 in accordance with the present invention.

FIG. 3B as shown.

FIG. 3C is a top planar view of a spike 340 for enhancing the traction of continuous track in accordance with the present invention.

FIG. 3C as shown.

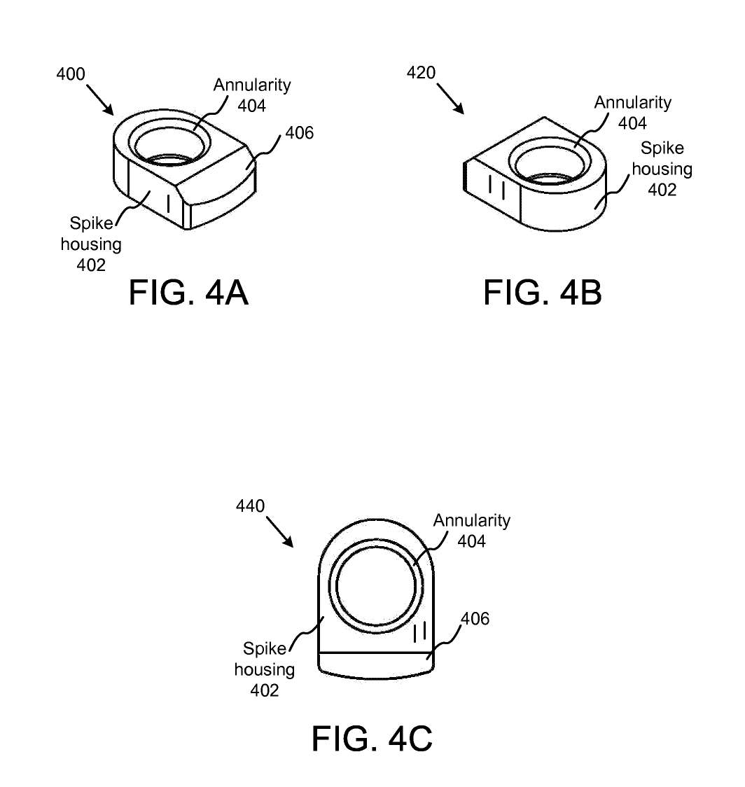

FIG. 4A is a rear elevational perspective view of a spike receptacle 400 in accordance with the present invention. The spike receptacle 400 comprises a spike housing 402, an annularity 404, and beveled component 406.

The spiked housing 402 is made of steel or a metal alloy which is bored to receive the spike 306. The annularity 404 comprises the beveled upper edge of the bore as shown. The beveled edge is wider at its height than is the bore itself through its height.

The beveled component 406 comprises a beveled edge of the housing 402. The housing 402 is beveled to facilitate the addition of metal and/or metal alloys during welding of the housing 402 to a grouser 104. In the shown embodiment, the bore traverses the entire height of housing 402.

FIG. 4B is a forward elevational perspective view of a spike receptacle 420 in accordance with the present invention.

The spike housing 402 in the shown figure comprising an annularity 404, or bore, through which the spike 306 is detachably inserted. The annularity 404 traverses the entire heights of the spike housing 402, such that annularity is open and accessible at both ends of the spike housing 402. Thus, if the stud or spike 306 breaks while the subject vehicle is in motion, it can pushed out through the open bottom portion of the annularity using means known to those of skill in the art.

FIG. 4B as shown.

FIG. 4C is a top planar view of a spike 440 for enhancing the traction of continuous track in accordance with the present invention.

FIG. 4C as shown.

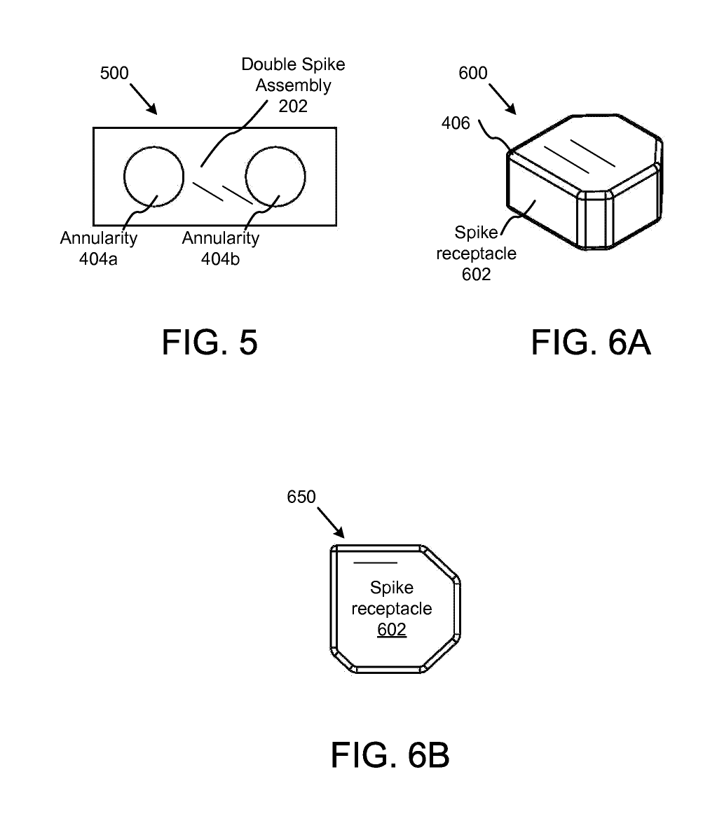

FIG. 5 is a top planar view of a spike receptacle in accordance with the present invention.

FIG. 5 as shown.

FIG. 6A is a side elevational perspective view of a spike receptacle 600 in accordance with the present invention. The spike receptacle 600 comprises a housing 602 and beveled edges 406.

The housing 602 in the shown embodiment is polygonal, or radiant shaped, with one corner being angled at 90 degrees. The housing may be bored through any of its edges with a bore for receiving the detachable spike 306. The housing 602 may likewise be welded or bolted at any of its edges to a grouser 104 or shoe 102. In some embodiments of the present invention, the spike 306 is detachably inserted directly into a shoe 102.

The edges of the housing 602 are beveled.

FIG. 6B is a top plan view of a spike receptacle in accordance with the present invention.

FIG. 6B as shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A traction enhanced continuous track structure comprising:
a plurality of sprockets disposed on a mechanized vehicle for constructing buildings;
a continuous track disposed around the sprockets comprising a plurality of ground engaging shoes;
a plurality of spike receptacles affixed to one or more of the shoes, the spike receptacles defining one or more annularities for receiving detachable spikes between 1 millimeter and 20 centimeters in diameter; and
a plurality of spikes detachably inserted into the spike receptacles, where in the spikes protrude outwardly away from the continuous track.

2. The traction enhanced continuous track structure of claim 1, wherein the spike receptacles are welded to the outside surface of a shoe.

3. The traction enhanced continuous track structure of claim 1, wherein the spike receptacles are welded to one or more grousers on the continuous track.

4. The traction enhanced continuous track structure of claim 1, wherein the spike receptacles are bolted to one or more grousers on the continuous track.

5. The traction enhanced continuous track structure of claim 1, wherein the spikes comprise drill bit tips.

6. The traction enhanced continuous track structure of claim 1, wherein the spikes are detachable upon being rotated one of clockwise and counterclockwise.

7. The traction enhanced continuous track structure of claim 1, wherein the spikes comprise one or more of tungsten carbide, polycrystalline diamond, cobalt steel, stainless steel, and iron.

8. The traction enhanced continuous track structure of claim 1, wherein the spikes are conical in shape.

9. The traction enhanced continuous track structure of claim 1, wherein the spike receptacles are bored in a direction orthogonal to the direction of protrusion of the spikes such the housing may be bolted to a grouser on a continuous track.

10. A spike receptacle for enhancing traction of continuous track on a mechanized vehicle, the spike receptacle comprising:
a housing defining one or more annularities for receiving detachable spikes; and
one or more spikes, each spike detachably inserted into single annularity, wherein the spikes protrude outwardly from the housing such that the spikes are parallel in orientation.

11. The spike receptacle of claim 9, wherein the spikes comprise drill bit tips.

12. The spike receptacle of claim 9, wherein the housing comprising a metal alloy.

13. The spike receptacle of claim 9, wherein the housing is bored in a direction orthogonal to the direction of protrusion of the spikes such the housing may be bolted to a grouser on a continuous track using the bore.

14. The traction enhanced continuous track structure of claim 1, wherein the spikes are each machined to define a recess circumventing each respective spike, the recess for receiving a tool for extracting spikes from the grouser.

15. A traction enhanced continuous track structure comprising:
a plurality of sprockets disposed on a mechanized vehicle for constructing buildings;
a continuous track disposed around the sprockets comprising a plurality of ground engaging shoes;
a plurality of grousers affixed to the shoes, each of the grousers defining spike receptacles on an outward edge of each grousers, the spike receptacles defining one or more annularities for receiving detachable spikes between 1 millimeter and 20 centimeters in diameter; and
a plurality of spikes detachably inserted into the spike receptacles, wherein the spikes protrude outwardly away from the shoes.

16. The traction enhanced continuous track structure of claim 15, wherein the spikes are each machined to define a recess circumventing each respective spike, the recess for receiving a tool for extracting spikes from the grouser.

17. The traction enhanced continuous track structure of claim 15, wherein the spikes rotate freely within the spike receptacles around the spike's longitudinal axis.

18. A traction enhanced continuous track structure comprising:
a plurality of sprockets disposed on a mechanized vehicle for constructing buildings;
a continuous track disposed around the sprockets comprising a plurality of ground engaging shoes wherein each of the shoes define one or more bores for receiving detachable spikes between 1 millimeter and 20 centimeters in diameter; wherein the annularites are beveled along their outer edge; and
a plurality of spikes detachably inserted into the spike receptacles, wherein the spikes protrude outwardly away from the shoes.
